(19) United States
(12) Patent Application Publication
(10) Pub. No.: US 2017/0054585 A1
(43) Pub. Date: Feb. 23, 2017

(54) ENHANCED COMMUNICATION PERFORMANCE UNDER VOICE SERVICES OVER ADAPTIVE MULTI-USER CHANNELS ON ONE SLOT (VAMOS) PAIRING

(71) Applicant: QUALCOMM Incorporated, San Diego, CA (US)

(72) Inventors: Cetin Altan, Farnborough (GB); Hassan Rafique, Farnborough (GB); Divaydeep Sikri, Woking (GB); Zhi-Zhong Yu, Reading (GB)

(21) Appl. No.: 14/827,511

(22) Filed: Aug. 17, 2015

(51) Int. Cl. H04L 27/26

(52) U.S. Cl. CPC H04L 27/2649; H04L 27/261

(57) ABSTRACT

Enhancing mobile communication performance under Voice services over Adaptive Multi-user channels on One Slot (VAMOS) pairing with receiving a multiplexed signal, wherein the multiplexed signal includes a first user signal having a first amplitude and a second user signal having a second amplitude, computing a subchannel power imbalance ratio (SCPIR) based on the first amplitude of the first user signal and the second amplitude of the second user signal, performing a channel estimation for the first user signal and the second user signal, obtaining at least one channel parameter from the channel estimation, and performing a user signal demodulation for the first user signal or the second user signal using the at least one channel parameter.

### FIELD

Aspects of the disclosure relate generally to wireless communication and more particularly, but not specifically, to enhancing mobile communication performance under Voice services over Adaptive Multi-user channels on One Slot (VAMOS) pairing.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is a global system for mobile communications (GSM) network. Enhanced general packet radio service (EGPRS) is an extension of GSM technology providing increased data rates beyond those available in second-generation GSM technology. EGPRS is also known as Enhanced Data rates for GSM Evolution (EDGE).

In conventional GSM wireless communication technology, different users are multiplexed by using time division multiple access (TDMA), where within one frequency channel each user is allocated resources according to a time schedule, dividing up resources among users using one time slot per user. VAMOS (Voice services over Adaptive Multi-user channels on One Slot) is an enhancement that enables doubling of the standard network capacity for voice calls. Specifically, in VAMOS, different training sequence codes are used to enable a base station to multiplex (or pair) two users onto the same resource (i.e., the same frequency and the same time slot). In addition, to facilitate sharing of the resource, lower transmit power may be allocated to each user as compared to conventional GSM.

If two or more mobile devices share the same VAMOS channel, the signals from the mobile devices will interfere on the VAMOS channel. For example, when the subchannel power imbalance ratio (SCPIR) is, for example, 0 dB, a VAMOS channel may experience, for example, 3 dB less power (as compared to conventional GSM) due to peak to average effect in the VAMOS channel.

### SUMMARY

The following presents a simplified summary of some aspects of the disclosure in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

Aspects of the disclosure are directed to apparatus and methods for enhancing mobile communication performance under Voice services over Adaptive Multi-user channels on One Slot (VAMOS) pairing.

According to various aspects, disclosed is a method of wireless communication, including receiving a multiplexed signal, wherein the multiplexed signal includes a first user signal having a first amplitude and a second user signal having a second amplitude; computing a subchannel power imbalance ratio (SCPIR) based on the first amplitude of the first user signal and the second amplitude of the second user signal; performing a channel estimation for the first user signal and the second user signal; obtaining at least one channel parameter from the channel estimation; and performing a user signal demodulation for the first user signal or the second user signal using the at least one channel parameter.

According to various aspects, disclosed is an apparatus for wireless communication, including a memory; an antenna for receiving a multiplexed signal, wherein the multiplexed signal includes a first user signal having a first amplitude and a second user signal having a second amplitude; a controller coupled to the memory for computing a subchannel power imbalance ratio (SCPIR) based on the first amplitude of the first user signal and the second amplitude of the second user signal; and a receiver coupled to the controller and the antenna for the following: performing a channel estimation for the first user signal and the second user signal; obtaining at least one channel parameter from the channel estimation; and performing a user signal demodulation for the first user signal or the second user signal using the at least one channel parameter.

According to various aspects, disclosed is an apparatus for wireless communication, including: a memory; means for receiving a multiplexed signal, wherein the multiplexed signal includes a first user signal having a first amplitude and a second user signal having a second amplitude; means for computing a subchannel power imbalance ratio (SCPIR) based on the first amplitude of the first user signal and the second amplitude of the second user signal; means for performing a channel estimation for the first user signal and the second user signal; means for obtaining at least one channel parameter from the channel estimation; and means for performing a user signal demodulation for the first user signal or the second user signal using the at least one channel parameter.

According to various aspects, disclosed is a computer-readable storage medium storing computer executable code, operable on a device including at least one processor; a memory for storing a subchannel power imbalance ratio (SCPIR) threshold, the memory coupled to the at least one processor; and the computer executable code including: instructions for causing the at least one processor to receive a multiplexed signal, wherein the multiplexed signal includes a first user signal having a first amplitude and a second user signal having a second amplitude; instructions for causing the at least one processor to compute a subchannel power imbalance ratio (SCPIR) based on the first amplitude of the first user signal and the second amplitude of the second user signal; instructions for causing the at least one processor to compare the SCPIR to the SCPIR threshold to generate a comparison; instructions for causing the at least one processor to perform a channel estimation for the first user signal and the second user signal based on the comparison; instructions for causing the at least one processor to obtain at least one channel parameter from the channel estimation; and instructions for causing the at least one processor to perform a user signal demodulation for the first user signal or the second user signal using the at least one channel parameter.

These and other aspects of the disclosure will become more fully understood upon a review of the detailed description, which follows. Other aspects, features, and implementations of the disclosure will become apparent to those of ordinary skill in the art, upon reviewing the following description of specific, implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 is a conceptual diagram illustrating an example of an access network in which one or more aspects of the disclosure may find application.

FIG. 2 is a block diagram conceptually illustrating an example of a communication system in which one or more aspects of the disclosure may find application.

FIG. 3 is a conceptual diagram illustrating an example of a radio protocol architecture implemented at an apparatus according to some aspects of the disclosure.

FIG. 4 is a block diagram illustrating an example of a hardware implementation for an apparatus employing a processing system according to some aspects of the disclosure.

FIG. 5 is a diagram illustrating an example of frame and burst formats in GSM according to some aspects of the disclosure.

FIG. 6 is a diagram illustrating an example of combining multiple subchannels into a single burst.

FIG. 7 is a flow diagram illustrating an example of enhancing mobile communication performance under Voice services over Adaptive Multi-user channels on One Slot (VAMOS) pairing.

FIG. 8 is a block diagram illustrating select components of an apparatus configured to enhance communication performance under VAMOS pairing according to some aspects of the disclosure.

FIG. 9 is a block diagram conceptually illustrating an example of a base station in communication with a UE in a communication system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

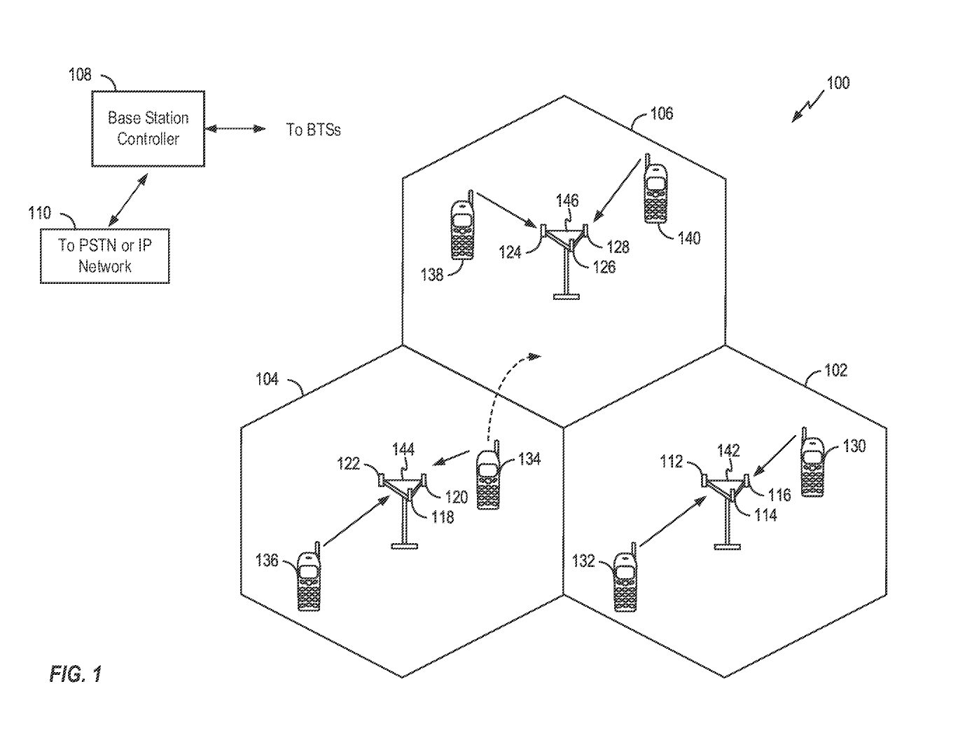

The various concepts presented throughout this disclosure may be implemented across a broad variety of communication systems, network architectures, and communication standards. FIG. 1 is a conceptual diagram illustrating an example of an access network in which one or more aspects of the disclosure may find application. Referring to FIG. 1, by way of example and without limitation, a simplified access network 100 in a GSM/EDGE architecture is illustrated. A GSM EDGE radio access network (GERAN) is one example of a RAN that may be utilized in accordance with the disclosure.

The network 100 includes multiple cellular regions (cells), including cells 102, 104, and 106, each of which may include one or more sectors. Cells may be defined geographically, e.g., by coverage area. In a cell that is divided into sectors, the multiple sectors within a cell can be formed by groups of antennas with each antenna responsible for communication with UEs in a portion of the cell. For example, in cell 102, antenna groups 112, 114, and 116 may each correspond to a different sector. In cell 104, antenna groups 118, 120, and 122 may each correspond to a different sector. In cell 106, antenna groups 124, 126, and 128 may each correspond to a different sector.

The cells 102, 104, and 106 may include several UEs that may be in communication with one or more sectors of each cell 102, 104, or 106. For example, UEs 130 and 132 may be in communication with a base transceiver station (BTS) 142, UEs 134 and 136 may be in communication with a BTS 144, and UEs 138 and 140 may be in communication with a BTS 146.

The network 100 includes one or more base station controllers (BSC) 108 and a core network 110 providing access to a public switched telephone network (PSTN) (e.g., via a mobile switching center/visitor location register (MSC/VLR)) and/or to an IP network (e.g., via a packet data switching node (PDSN)). Here, each BTS 142, 144, and 146 may be configured to provide an access point to the core network 110 for all the UEs 130, 132, 134, 136, 138, and 140 in the respective cells 102, 104, and 106.

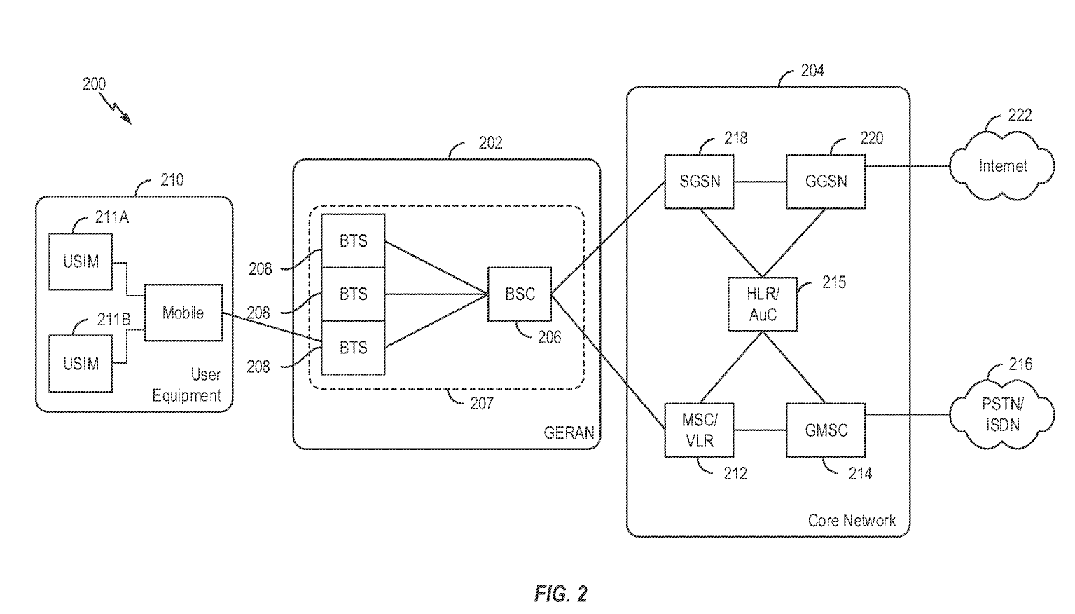

FIG. 2 is a block diagram conceptually illustrating an example of a communication system in which one or more aspects of the disclosure may find application. Referring now to FIG. 2, as an illustrative example without limitation, various aspects of the present disclosure are illustrated with reference to a GSM system 200. A GSM system includes three interacting domains: a core network 204 (e.g., a GSM/GPRS core network), a radio access network (RAN) (e.g., the GSM/EDGE Radio Access Network (GERAN) 202), and user equipment (UE) 210. In this example, the illustrated GERAN 202 may employ a GSM air interface for enabling various wireless services including telephony, video, data, messaging, broadcasts, and/or other services. The GERAN 202 may include a plurality of Radio Network Subsystems (RNSs) such as an RNS 207, each controlled by a respective Base Station Controller (BSC) such as a BSC 206. Here, the GERAN 202 may include any number of BSCs 206 and RNSs 207 in addition to the illustrated BSCs 206 and RNSs 207. The BSC 206 is an apparatus responsible for, among other things, assigning, reconfiguring, and releasing radio resources within the RNS 207.

The geographic region covered by the RNS 207 may be divided into a number of cells, with a radio transceiver apparatus serving each cell. A radio transceiver apparatus is commonly referred to as a base transceiver station (BTS) in GSM applications, but may also be referred to by those skilled in the art as a base station (BS), a Node B, a radio base station, a radio transceiver, a transceiver function, a basic service set (BSS), an extended service set (ESS), an access point (AP), or some other suitable terminology. For clarity, three BTSs 208 are shown in the illustrated RNS 207; however, the RNSs 207 may include any number of wireless BTSs 208. The BTSs 208 provide wireless access points to a GSM/GPRS core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning devices. The mobile apparatus is commonly referred to as user equipment (UE) in GSM applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The GSM “Um” air interface generally utilizes GMSK modulation (although later enhancements such as EGPRS, described below, may utilize other modulation such as 8PSK), combining frequency hopping transmissions with time division multiple access (TDMA), which divides a frame into 8 time slots. Further, frequency division duplexing (FDD) divides uplink and downlink transmissions using a different carrier frequency for the uplink than that used for the downlink. Those skilled in the art will recognize that although various examples described herein may refer to GSM Um air interface, the underlying principles are equally applicable to any other suitable air interfaces.

In some aspects of the disclosure, the GSM system 200 may be further configured for enhanced GPRS (EGPRS). EGPRS is an extension of GSM technology providing increased data rates beyond those available in 2G GSM technology. EGPRS is also known in the field as Enhanced Data rates for GSM Evolution (EDGE), and IMT Single Carrier.

Specific examples are provided below with reference to the GERAN system. However, the concepts disclosed in various aspects of the disclosure can be applied to any time-division-based system, such as but not limited to a UMTS system using a TDD air interface, or an e-UTRA system using a TD-LTE air interface.

That is, in some aspects of the disclosure, the UE 210 may include a plurality of universal integrated circuit cards (UICC), each of which may run one or more universal subscriber identity module (USIM) applications 211. A USIM stores the subscriber's identity, and provides a user's subscription information to a network as well as performing other security and authentication roles. The illustrated UE 210 includes two USIMs 211A and 211B, but those of ordinary skill in the art will understand that this is illustrative in nature only, and a UE may include any suitable number of USIMs.

For illustrative purposes, one UE 210 is shown in communication with one BTS 208 in FIG. 2. The downlink (DL), also called the forward link, refers to the communication link from a BTS 208 to a UE 210, and the uplink (UL), also called the reverse link, refers to the communication link from a UE 210 to a BTS 208.

The core network 204 can interface with one or more access networks, such as the GERAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The illustrated GSM core network 204 includes a circuit-switched (CS) domain and a packet-switched (PS) domain. Some of the circuit-switched elements are a Mobile services Switching Centre (MSC) 212, a Visitor Location Register (VLR) 212, and a Gateway MSC (GMSC) 214. Packet-switched elements include a Serving GPRS Support Node (SGSN) 218 and a Gateway GPRS Support Node (GGSN) 220. Some network elements, like EIR, HLR 215, VLR 212, and AuC 215 may be shared by both the circuit-switched and packet-switched domains.

In the illustrated example, the core network 204 supports circuit-switched services with a MSC 212 and a GMSC 214. In some applications, the GMSC 214 may be referred to as a media gateway (MGW). One or more BSCs, such as the BSC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR 218 is also associated with an authentication center (AuC) 215 that contains subscriber-specific authentication data. When a call is received for a particular UE, the GMSC 214 queries the HLR 215 to determine the UE's location and forwards the call to the particular MSC serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the GERAN 202 to a packet-based network 222. The packet-based network 222 may be the Internet, a private data network, or some other suitable packet-based networks. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

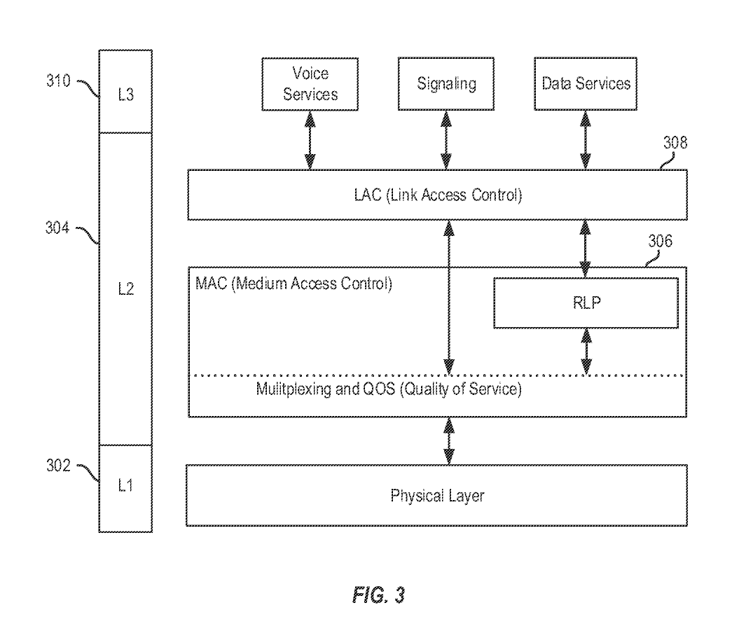

The UE 210, which may be one of the UEs of FIG. 1, may be adapted to employ a protocol stack architecture for communicating data between the UE 210 and one or more network nodes of the GSM system 200 (e.g., the BTS 208). A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base. FIG. 3 is a conceptual diagram illustrating an example of a radio protocol architecture implemented at an apparatus (e.g., UE 210) according to some aspects of the disclosure. The protocol stack architecture for the UE 210 is shown to generally include three layers: Layer 1 (L1), Layer 2 (L2), and Layer 3 (L3).

Layer 1 302 is the lowest layer and implements various physical layer signal processing functions. Layer 1 302 is also referred to herein as the physical layer 302. This physical layer 302 provides for the transmission and reception of radio signals between the UE 210 and a BTS 208.

The data link layer, called layer 2 (or “the L2 layer”) 304 is above the physical layer 302 and is responsible for delivery of signaling messages generated by Layer 3. The L2 layer 304 makes use of the services provided by the physical layer 302. The L2 layer 304 may include two sublayers: the Medium Access Control (MAC) sublayer 306, and the Link Access Control (LAC) sublayer 308.

The MAC sublayer 306 is the lower sublayer of the L2 layer 304. The MAC sublayer 306 implements the medium access protocol and is responsible for transport of the higher layers' protocol data units using the services provided by the physical layer 302. The MAC sublayer 306 may manage the access of data from the higher layers to the shared air interface. The MAC sublayer 306 also may include or interface with radio link protocol (RLP) functions, multiplexing functions, and QoS functions.

The LAC sublayer 308 is the upper sublayer of the L2 layer 304. The LAC sublayer 308 implements a data link protocol that provides for the correct transport and delivery of signaling messages generated at the layer 3. The LAC sublayer makes use of the services provided by the lower layers (e.g., layer 1 and the MAC sublayer).

Layer 3 310, which may also be referred to as the upper layer or the L3 layer, originates and terminates signaling messages according to the semantics and timing of the communication protocol between a BTS 208 and a UE 210. The L3 layer 310 makes use of the services provided by the L2 layer. Information (e.g., voice service, data services, and signaling) messages are also passed through the L3 layer 310.

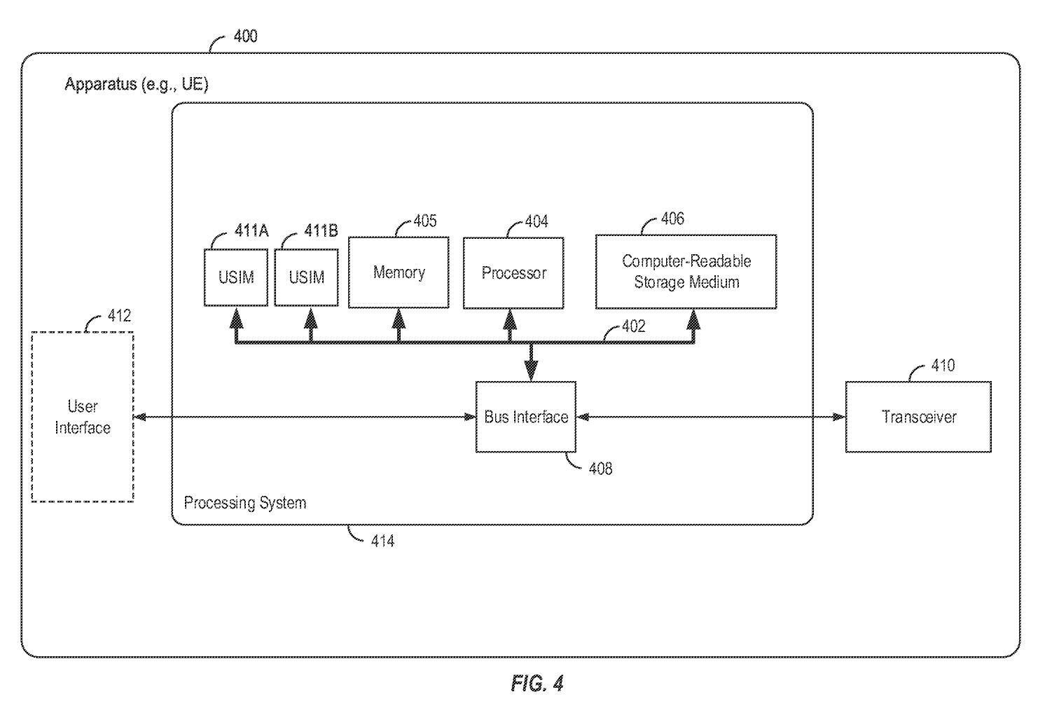

FIG. 4 is a block diagram illustrating an example of a hardware implementation for an apparatus 400 (e.g., a UE or a mobile station) employing a processing system 414. In accordance with various aspects of the disclosure, an element, or any portion of an element, or any combination of elements may be implemented with a processing system 414 that includes one or more processors 404. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits or components including one or more processors (represented generally by the processor 404), a memory 405, computer-readable storage media (represented generally by the computer-readable storage medium 406), and one or more USIMs (e.g., dual USIMs 411A and 411B). The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a means for communicating with various other apparatus over a transmission medium.

Depending upon the nature of the apparatus, a user interface 412 (e.g., keypad, display, speaker, microphone, joystick) may also be provided. The processor 404 is responsible for managing the bus 402 and general processing, including the execution of software stored on the computer-readable storage medium 406. The software, when executed by the processor 404, causes the processing system 414 to perform the various functions described infra for any particular apparatus. The computer-readable storage medium 406 may also be used for storing data that is manipulated by the processor 404 when executing software.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 406. The computer-readable storage medium 406 may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 406 may reside in the processing system 414, external to the processing system 414, or distributed across multiple entities including the processing system 414. The computer-readable storage medium 406 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

VAMOS allows multiplexing of two users simultaneously on the same physical resource, using the same timeslot number, absolute RF channel number (ARFCN), and TDMA frame number for GSM traffic. Thus, a basic physical channel that is VAMOS-capable may support up to four traffic channels (TCH) along with their associated control channels.

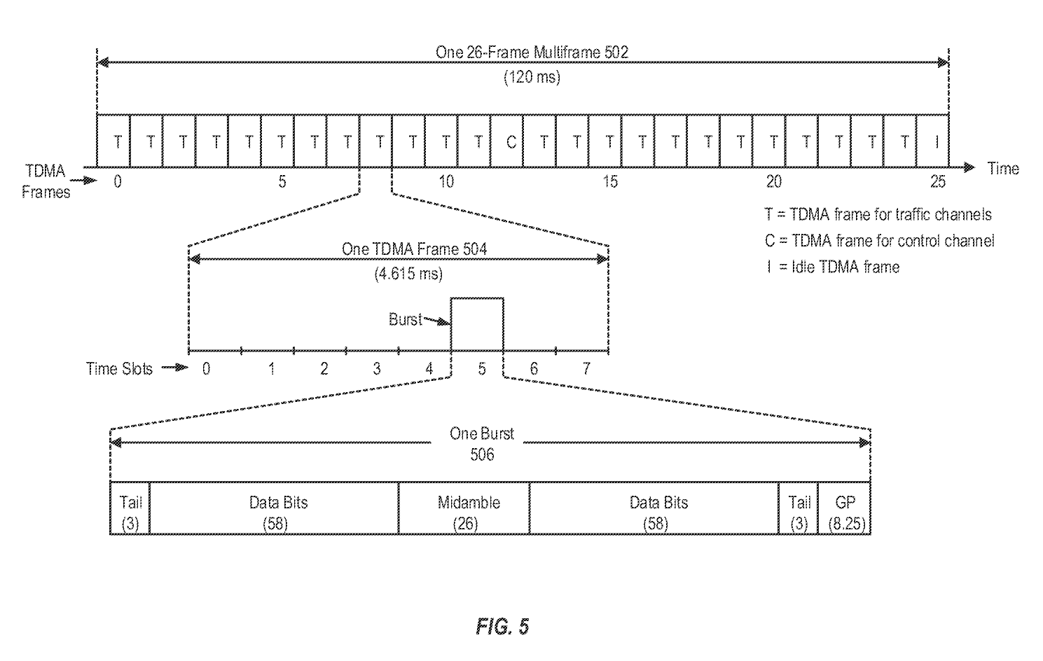

FIG. 5 is a diagram illustrating an example of frame and burst formats in GSM according to some aspects of the disclosure. FIG. 5 shows example frame and burst formats in GSM. These frame and burst formats may be used for the uplink and downlink. The timeline for transmission is divided into a number of frames (e.g., a multiframe 502). For traffic channels used to transmit user-specific data, each multiframe 502 in this example includes 26 TDMA frames 504, which are labeled as TDMA frames 0 through 25. The traffic channels are sent in TDMA frames 0 through 11 and TDMA frames 13 through 24 of each multiframe 502. A control channel is sent in TDMA frame 12. No data is sent in an idle TDMA frame 25, which is used by wireless communication devices to make measurements of signals transmitted by neighbor base stations.

Each time slot within a frame is also referred to as a “burst” 506 in GSM. Each burst 506 includes two tail fields, two data fields, a training sequence (or midamble) field and a guard period (GP). The number of symbols in each field is shown inside the parentheses. A burst 506 includes symbols for the tail, data, and midamble fields. No symbols are sent in the guard period. TDMA frames of a particular carrier frequency are numbered and formed in groups of 26 or 51 TDMA frames 504 called multiframes 502.

Also, each base station is assigned one or more carrier frequencies. Each carrier frequency is divided into eight time slots (which are labeled as time slots 0 through 7) using TDMA such that eight consecutive time slots form one TDMA frame with a duration of 4.615 milliseconds (ms). A physical channel occupies one time slot within a TDMA frame. Each active wireless communication device or user is assigned one or more time slot indices for the duration of a call. User-specific data for each wireless communication device is sent in the time slot(s) assigned to that wireless communication device and in TDMA frames used for the traffic channels.

In VAMOS, a pair of TCH channels along with their associated control channels sharing the same timeslot number, ARFCN, and TDMA frame number is referred to as a VAMOS pair. The TCH channels along with their associated control channels in a VAMOS pair are referred to as VAMOS subchannels. In a VAMOS pair, each VAMOS subchannel is assigned a training sequence that is different from the training sequence assigned to the other VAMOS subchannel. In addition, for uplink traffic, two Gaussian minimum shift keying (GMSK) modulated symbols are transmitted simultaneously in the same radio resource, identified by the same timeslot number, ARFCN, and TDMA frame number, in a given cell. For downlink traffic, a pair of corresponding bits from the TCHs and associated control channels in the VAMOS pair is mapped to an adaptive quadrature phase shift keying (AQPSK) modulation symbol. In various examples, each VAMOS subchannel may be coherent with the other VAMOS subchannel. For example, each VAMOS subchannel in the downlink may be coherent with the other VAMOS subchannel.

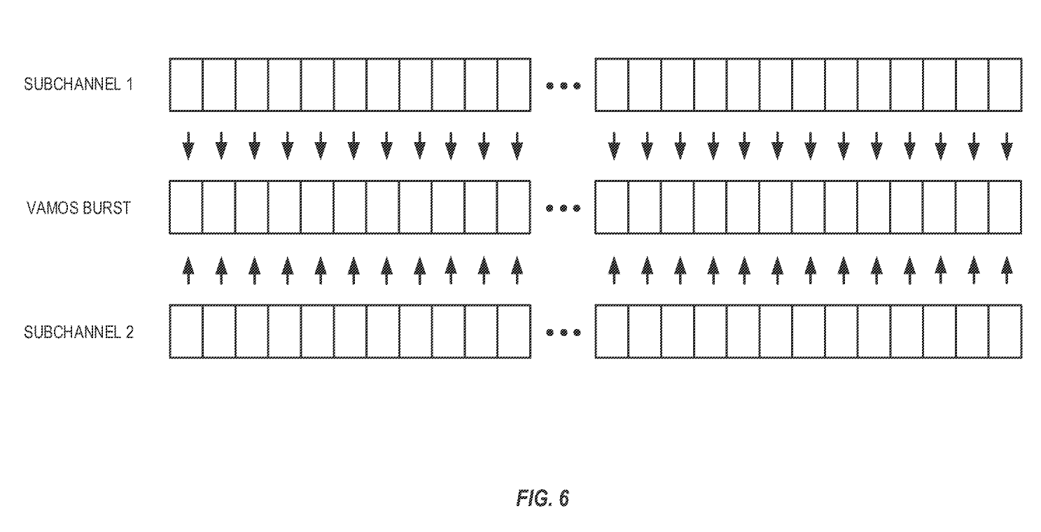

FIG. 6 is a diagram illustrating an example of combining multiple subchannels into a single burst. FIG. 6 illustrates, in a conceptual manner, that the symbols of two subchannels are combined to provide a VAMOS burst. Since the subchannels are sharing the same physical resource, the symbols of the two subchannels will interfere with each other. For example, when SCPIR=0 dB (SCPIR may be allowed to vary, for example, from +10 dB to −10 dB), a VAMOS channel may receive 3 dB less power due to the peak to average effect of the interference in the VAMOS channel.

As an example, the Global System for Mobile Communications (GSM) wireless system includes a channel multiplexing feature; that is, Voice services over Adaptive Multi-user channels on One Slot (VAMOS). VAMOS is used to increase the voice capacity of the system. In VAMOS, two users share a time slot on the same frequency, for example, by using orthogonal subchannels in a quadrature phase shift keying (QPSK) transmission. In QPSK transmission the orthogonal subchannels are known as an in- phase subchannel and a quadrature subchannel, nominally 90 degrees offset in phase. One user signal may be placed onto the in-phase subchannel of the QPSK transmission and another user signal may be placed onto the quadrature subchannel of the QPSK transmission. VAMOS may be used to increase the voice capacity of the system. As an example, VAMOS employs distinct digital training sequences to differentiate between the two user signals using the same time slot on the same frequency.

When two user signals are paired in VAMOS, each user signal is treated as interference by the other. A performance metric for the relative interference level is Subchannel Power Imbalance Ratio (SCPIR). A weaker subchannel is the subchannel with a weaker receive power level. A stronger subchannel is the subchannel with a stronger receiver power level. For example, SCPIR is the ratio of the weaker receive power level over the stronger receive power level for two subchannels. In a harsh SCPIR scenario, there is a large power imbalance between the two paired subchannels, where the SCPIR has a small numeric value (e.g. large negative value in decibels). A harsh SCPIR scenario results in a performance degradation on the weaker subchannel.

In various VAMOS scenarios, which pair a stronger subchannel with a weaker subchannel, interference cancellation techniques with an equalizer may be used to subtract the stronger subchannel interference from the received signal to obtain the user signal of the weaker subchannel. For example, each subchannel may use its own training sequence to obtain a timing reference and a frequency estimate for the interference cancellation. Interference cancellation (e.g., including usage of a deterministic digital sequence for setting equalizer parameters) may be performed independently of the SCPIR level. For example, interference cancellation with an equalizer may be performed without regard to the SCPIR level. In such examples, a harsh SCPIR scenario may result in performance degradation since strong interference from the stronger subchannel may severely impact the performance of the weaker subchannel. For example, good performance of the weaker subchannel may require accurate time referencing and frequency estimation. In various examples, an equalizer may be used to compensate a frequency response in the propagation channel between a transmitter and a receiver. If the frequency response in the propagation channel is represented by a complex function of frequency H(f), an equalizer may attempt to compensate by providing an equalizer frequency response C(f) such that the product of H(f) and C(f) is approximately constant over a desired frequency range. A benefit of equalization may be improved timing reference and frequency estimation for the user signal of the weaker subchannel.

However, in various examples, receiver performance may be improved in a harsh SCPIR scenario when VAMOS pairing is active. For example, a training sequence (a.k.a. training sequence of a stronger subchannel) may be used to subtract the stronger subchannel from the received signal to enable obtaining the weaker subchannel from the received signal.

In various examples, in a harsh SCPIR scenario, the training sequence from the stronger subchannel (i.e., “the stronger training sequence”) may be used to obtain timing reference and frequency estimation for the weaker subchannel. That is, the timing reference and frequency estimation for the weaker subchannel is not obtained using its own training sequence. And, once the timing reference and frequency estimation for the weaker subchannel are obtained, they are used to derive the weaker subchannel. Also, in various examples, the training sequence from the stronger subchannel (i.e., “the stronger training sequence”) may be used to obtain timing reference and frequency estimation for the equalizer of the weaker subchannel. That is, the timing reference and frequency estimation for the equalizer of the weaker subchannel is not obtained using its own training sequence. And, once the timing reference and frequency estimation for the equalizer of the weaker subchannel are obtained, they are used by the equalizer of the weaker subchannel to derive the weaker subchannel.

In an example, a received signal may be expressed as follows:

x[n]=Σ_{m=0, . . . ,ν}h[m]*(λS1[n−m]+βS2[n−m]*j)+Z[n]+N[n] equation (1)

where:
ν=4
SCPIR=20 log (λ/β)
Z[n]=interference signal (i)
N[n]=Gaussian noise with zero mean and standard deviation σ
h[n]=[h^{c}₀, h^{c}₁, h^{c}₂, . . . h^{c}_{ν}]
n=0, 1, 2 . . . L and L=148 (in one example)
and wherein the “c” superscript denotes a complex term
S1[n]=[s1₀, s1₁, s1₂, . . . s1_{L}]
where S1[n−m] is a shifted version of S1[n] shifted by m in the positive direction (i.e., right direction)
S2[n]=[s2₀, s2₁, s2₂, . . . s2_{L}]
where S2[n−m] is a shifted version of S2[n] shifted by m in the positive direction (i.e., right direction)
λ is the amplitude of first user signal S1, and β is the amplitude of second user signal S2.

After expanding equation (1), we obtain:

x[n]=(Σ_{m=0, . . . ,ν}h[m]*λS1[n−m])+(Σ_{m=0, . . . ,ν}h[m]*βS2[n−m]*j)+Z[n]+N[n] equation (1a)

In various examples, equation (1a) may be converted into matrix notation by the following expression:

X=H₁S₁+H₂S₂+Z+N equation (2)

where:
H₁=λ*[h^{C}₀, h^{C}₁, h^{C}₂ . . . , h^{C}_{ν}]
H₂=β*[h^{C}₀, h^{C}₁, h^{C}₂ . . . , h^{C}_{ν}]*j
X=[X^{C}₁, X^{C}₂, X^{C}₃, . . . , X^{C}_{L}]
Z=[i^{C}₁, i^{C}₂, i^{C}₃, . . . , i^{C}_{L}]
N=[n^{C}₁, n^{C}₂,n^{C}₃, . . . , n^{C}_{L}]
and wherein the “c” superscript denotes a complex term.

In various examples, to obtain a desired user signal S1 from the received signal X, the contribution from the other user signal, represented by the term H₂S₂, may be suppressed. For example, with an estimate of H₂ and an estimate of S₂, the contribution from the other user signal may be subtracted from the received signal X. For example, a user signal S may be expressed in matrix form as:

$$S = \vert \begin{matrix}{S}_{0} & {S}_{1} & {S}_{2} & {S}_{3} & \cdot & {S}_{L} \\ - 1 & {S}_{0} & {S}_{1} & {S}_{2} & \cdot & {S}_{L - 1} \\ - 1 & - 1 & {S}_{0} & {S}_{1} & \cdot & {S}_{L - 2} \\ - 1 & - 1 & - 1 & {S}_{0} & \cdot & {S}_{L - 3} \\ - 1 & - 1 & - 1 & - 1 & \cdot & {S}_{L - v}\end{matrix} \vert \qquad equation ( 2 a )$$

Furthermore, in various examples, the channel estimation for the second subchannel may be implemented by the following equation:

ĥ₂[z]=1/LΣ_{k=0, . . . ,L}x_{tsc}[z+k]*Stsc2[k] for z=0,1, . . . ,ν equation (3)

where:
ĥ₂[z] denotes an estimate for the channel impulse response for the second subchannel and Stsc2 refers to the training sequence code (TSC) of the second subchannel.

Substituting equation (1) into equation (3) results in:

$${h}_{2}^{⋀} [ z ] = 1 / L {\sum }_{k … L} {\sum }_{m … v} h [ m ] * λ Stsc 1 [ z + k - m ] * Stsc 2 [ k ] + 1 / L {\sum }_{k … L} {\sum }_{m = 0 , … , v} h [ m ] * β Stsc 2 [ z + k - m ] * j * Stsc 2 [ k ] + 1 / L {\sum }_{k = 0 , … , L} Z [ z + k ] * Stsc 2 [ k ] + 1 / L {\sum }_{k = 0 , … , L} N [ z + k ] * Stsc 2 [ k ] \qquad equation ( 3 a )$$

and with further simplification,

$${h}_{2}^{⋀} [ z ] = ( 1 / L ) * λ * {\sum }_{m = 0 , … , v} h [ m ] * {\sum }_{k … L} Stsc 1 [ z + k - m ] * Stsc 2 [ k ] + ( 1 / L ) * β * {\sum }_{m = 0 , … , v} h [ m ] * {\sum }_{k … L} Stsc 2 [ z + k - m ] * Stsc 2 [ k ] * j + 1 / L {\sum }_{k = 0 , … , L} Z [ z + k ] * Stsc 2 [ k ] + 1 / L {\sum }_{k = 0 , … , L} N [ z + k ] * Stsc 2 [ k ] \qquad equation ( 3 b )$$

In various examples, assume that all cross-terms (a.k.a. “colored terms”) in equations (3a) and (3b) are negligible. That is, assume that the magnitude of cross-terms may have relatively low values compared to the magnitude of like terms. With this assumption, equation (3) simplifies to:

ĥ₂[z]=(1/L)*β*j{h[0]Σ_{k . . . L}Stsc2[z+k]*Stsc2[k]+h[1]Σ_{k . . . L}Stsc2[z+k−1]*Stsc2[k]+ . . . +h[v]Σ_{k . . . L}Stsc2[z+k−v]*Stsc2[k] equation (3c)

For example, equation (3c) yields the channel taps when the argument of the cross terms is the same where the corresponding summation reduces to approximately L. Therefore, for z=0, 1, 2, . . . , v

ĥ₂[z]≈β*j*h[z]≈h2[z] equation (3d)

Equalization using the other (i.e., stronger subchannel) TSC yields Ŝ₂ (ν, L), and channel estimation using the other TSC yields Ĥ₂ (1,ν). These two terms may be used to suppress the second subchannel contribution as follows:

Z=(Ĥ₂*Ŝ₂) equation (4)

Subtracting equation (4) from equation (2) yields:
X_{suppressed}=X−Z
X_{suppressed}=H₁*S₁+H₂*S₂+I+N−(Ĥ₂*Ŝ₂)
X_{suppressed}=H₁*S₁+γ+I+N
where γ=H₂*S₂−(Ĥ₂*Ŝ₂) and
wherein

limγ=0,Ĥ₂->>H₂,Ŝ₂->>S₂ equation (5)

In various examples, using the training sequence from a stronger subchannel (i.e., “a stronger training sequence”) to obtain timing reference and frequency estimation for a weaker subchannel results in the performance gain illustrated in the following table (Table 1):

TABLE 1

| | VAMOS subchannel | |
|---|---|---|
| TC/EQ* | suppression | |
| SCPIR (subchannel power | −8 dB | −10 dB |
| imbalance ratio) | | |
| ACI (adjacent channel | 16.43 dB | 16.91 dB |
| interference) | | |
| sensitivity | 2.05 dB | 1.62 dB |

*TC is test case and EQ is equalizer configuration.

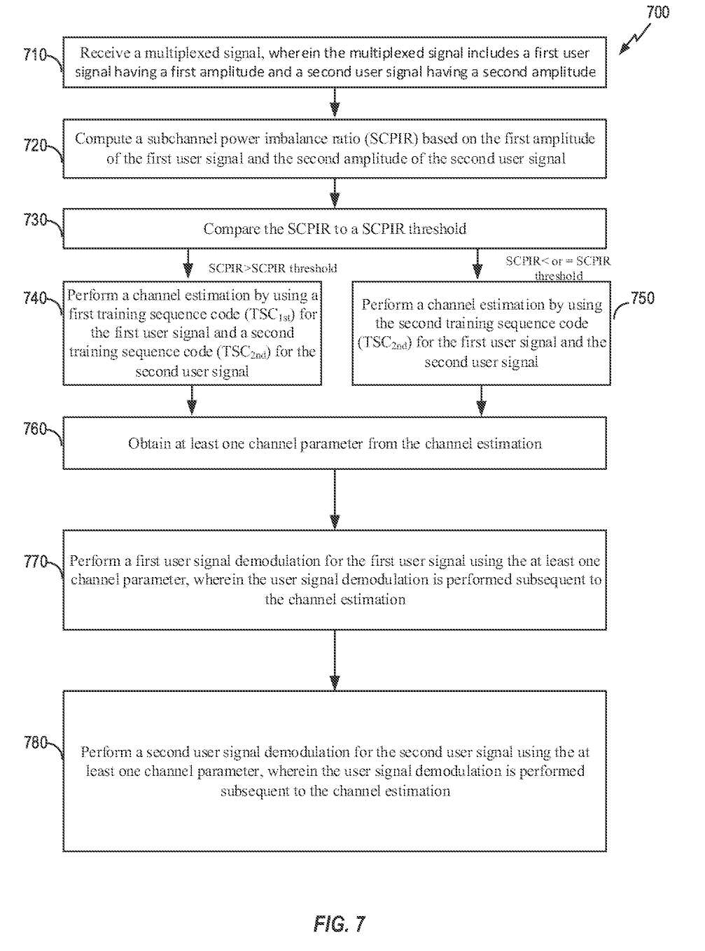

FIG. 7 is a flow diagram illustrating an example of enhancing mobile communication performance under Voice services over Adaptive Multi-user channels on One Slot (VAMOS) pairing.

In block 710, a receiver (e.g., receiver 816 or receiver 954) receives a multiplexed signal, wherein the multiplexed signal includes a first user signal having a first amplitude and a second user signal having a second amplitude. In some examples, the multiplexed signal is received by the receiver (e.g., receiver 816 or receiver 954) using an antenna (e.g., antenna 812 or antenna 952a).

In various examples, the first user signal and the second user signal share a common time slot and a common carrier frequency. In various examples, the multiplexed signal includes at least two orthogonal signal components. For example, the at least two orthogonal signal components may include an in-phase component and a quadrature component. For example, the at least two orthogonal signal components may be part of an adaptive quadrature phase shift keying (AQPSK) modulated signal.

In block 720, a controller or a processor (e.g., controller/processor 990 or processing circuit 810) computes a subchannel power imbalance ratio (SCPIR) based on the first amplitude of the first user signal and the second amplitude of the second user signal. In various examples, the subchannel power imbalance ratio (SCPIR) is computed as a function (F) of the first amplitude of the first user signal and the second amplitude of the second user signal. For example, the function (F) may be twenty (20) times a logarithm of a ratio of the first amplitude over the second amplitude. (i.e., F=20*log(first amplitude/second amplitude)).

In block 730, the controller or the processor (e.g., controller/processor 990 or processing circuit 810) compares the SCPIR to a SCPIR threshold to yield a comparison. The comparison may be that the SCPIR is greater than the SCPIR threshold; or the comparison may be that the SCPIR is less than or equal to the SCPIR threshold. In various examples, the SCPIR threshold is a predetermined SCPIR threshold. If the SCPIR is greater than the SCPIR threshold, the controller or the processor determines that interference from the second user signal to the first user signal is a benign interference scenario, and proceeds to block 740. A benign interference scenario is defined as when the interference from the second user signal to the first user signal is either negligible or moderate based on a predefined performance level for the application or as predefined by a user; that is, the interference is less than a predefined performance level.

If the SCPIR is less than or equal to the SCPIR threshold, the controller or the processor determines that interference from the second user signal to the first user signal is a harsh interference scenario or a harsh SCPIR scenario) and proceeds to block 750. A harsh interference scenario or a harsh SCPIR scenario is defined as when the interference from the second user signal to the first user signal is high, based on a predefined performance level for the application or as predefined by a user; that is, the interference is greater than or equal to a predefined performance level.

In block 740, the receiver (e.g., receiver 816 or receiver 954) performs a channel estimation (prior to user demodulation) by using a first training sequence code (TSC₁ₛₜ) for the first user signal and a second training sequence code (TSC_{2nd}) for the second user signal. That is, perform channel estimation for each user signal separately prior to user signal demodulation of the first user signal and/or the second user signal. In various examples, the first training sequence code (TSC₁ₛₜ) and the second training sequence code (TSC_{2nd}) are distinct digital training sequence codes which allow differentiating between the first user signal and the second user signal. In some examples, the first training sequence code (TSC₁ₛₜ) and the second training sequence code (TSC_{2nd}) include a low cross-correlation characteristic. In various examples, a low cross-correlation characteristic is defined as having magnitude values less than a predefined value, for example, as specified by a user. The low cross-correlation characteristic may facilitate differentiating between the first user signal and the second user signal.

In various examples, an adaptive filter within the receiver may be used to perform the channel estimation in block 740. In various examples, an equalizer within the receiver may be used to perform the channel estimation in block 740.

In block 750, the receiver (e.g., receiver 816 or receiver 954) performs a channel estimation by using the second training sequence code (TSC_{2nd}) for the first user signal and the second user signal. The second training sequence code (TSC_{2nd}) is associated with the second user signal. That is, the receiver performs the channel estimation for each of the first and second user signals as a single channel estimation. For example, the single channel estimation may be performed by using the second training sequence code (TSC_{2nd}). In various examples, the second training sequence code (TSC_{2nd}) is used since the second amplitude of the second user signal is higher than the first amplitude of the first user signal. In various examples, the second training sequence code may be a deterministic digital sequence, e.g., a series of binary values. In various examples, an adaptive filter within the receiver may be used to perform the channel estimation in block 750. In various examples, an equalizer within the receiver may be used to perform the channel estimation in block 750.

Following either from block 740 or block 750, in block 760, the receiver (e.g., receiver 816 or receiver 954) obtains at least one channel parameter from the channel estimation. For example, the channel parameters may include a timing reference and/or a frequency estimate.

In block 770, the receiver (e.g., receiver 816 or receiver 954) performs a user signal demodulation for the first user signal using the at least one channel parameter, wherein the user signal demodulation is performed subsequent to the channel estimation performed in either block 740 or block 750. In various examples, the at least one channel parameter used may be the timing estimate and/or the frequency estimate.

In various examples, the user signal demodulation for the first user signal may be performed by extracting one or more signal information (e.g., voice, video, image, data, etc.) from the first user signal using the at least one channel parameter. For example, the user signal demodulation may be viewed as an inverse operation of user signal modulation wherein one or more user information (e.g., voice, video, image, data, etc.) is inserted (i.e., modulated) onto a user signal (e.g., the first user signal). That is, the user signal demodulation is the extraction of the inserted user information from the user signal (e.g., the first user signal).

In block 780, the receiver (e.g., receiver 816 or receiver 954) performs a user signal demodulation for the second user signal using the at least one channel parameter, wherein the user signal demodulation is performed subsequent to the channel estimation performed in either block 740 or block 750. In various examples, the at least one channel parameter used may be the timing estimate and/or the frequency estimate. In various examples, the receiver (e.g., receiver 816 or receiver 954) subtracts the second user signal from the multiplexed signal to obtain a suppressed multiplexed signal (e.g., equation (5)), wherein the suppressed multiplexed signal is used for performing the user signal demodulation.

In various examples, the user signal demodulation for the second user signal may be performed by extracting one or more signal information (e.g., voice, video, image, data, etc.) from the second user signal using the at least one channel parameter. For example, the user signal demodulation may be viewed as an inverse operation of user signal modulation wherein one or more user information (e.g., voice, video, image, data, etc.) is inserted (i.e., modulated) onto a user signal (e.g., the second user signal). That is, the user signal demodulation is the extraction of the inserted user information from the user signal (e.g., the second user signal).

In various examples, performing user signal demodulation after performing channel estimation (e.g., as described in block 740 and/or block 750) may minimize the performance metric of bit error rate (BER) in a harsh interference scenario (i.e., a harsh SCPIR scenario). For example, channel estimation may be performed first to obtain channel parameter(s) (e.g., timing reference(s) and/or frequency estimate(s)) which may be needed for optimizing user signal demodulation performance. That is, the user signal demodulation may rely on channel parameter(s) from a channel estimation step prior to the user signal demodulation. Otherwise, performing the user signal demodulation before performing the channel estimation may result in a non-optimal performance (e.g., poor performance); that is, a degraded BER.

In the various blocks of FIG. 7, wherein the steps are performed by the controller or the processor (e.g., controller/processor 990 or processing circuit 810), in certain examples, the controller or the processor is coupled to a memory (e.g., memory 992 or storage memory 804 and one or more of its associated modules 850, 852) for performing the various steps. In various aspects, the controller or the processor is configured for performing the steps in one or more of the various blocks of FIG. 7. In various aspects, the receiver is configured for performing the steps in one or more of the various blocks of FIG. 7.

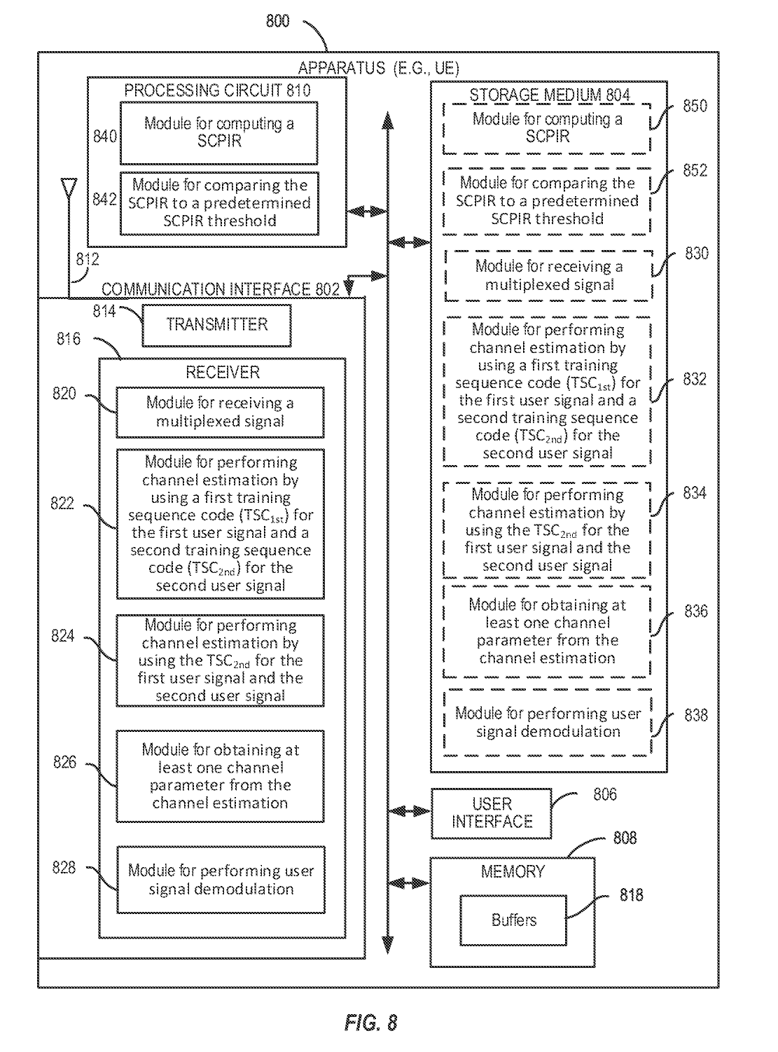

FIG. 8 is a block diagram illustrating select components of an apparatus 800 (e.g., the UE 210) configured to enhance communication performance under VAMOS pairing according to some aspects of the disclosure. The apparatus 800 includes a communication interface (e.g., at least one transceiver) 802, a storage medium 804, a user interface 806, a memory 808, and a processing circuit 810. These components may be coupled to and/or placed in electrical communication with one another via a signaling bus or other suitable component. In particular, each of the communication interface 802, the storage medium 804, the user interface 806, and the memory 808 are coupled to and/or in electrical communication with the processing circuit 810.

The communication interface 802 may be adapted to facilitate wireless communication of the apparatus 800. For example, the communication interface 802 may include circuitry and/or programming adapted to facilitate the communication of information bi-directionally with respect to one or more communication devices in a network. The communication interface 802 may be coupled to one or more antennas 812 for wireless communication within a wireless communication system. The communication interface 802 may be configured with one or more standalone receivers and/or transmitters, as well as one or more transceivers. In the illustrated example, the communication interface 802 includes a transmitter 814 and a receiver 816.

The memory 808 may represent one or more memory devices. As indicated, the memory 808 may maintain various buffers 818 (e.g., scheduled flow buffer and non-scheduled flow buffer) along with other information used by the apparatus 800. In some implementations, the memory 808 and the storage medium 804 are implemented as a common memory component. The memory 808 may also be used for storing data that is manipulated by the processing circuit 810 or some other component of the apparatus 800.

The storage medium 804 may represent one or more computer-readable, machine-readable, and/or processor-readable devices for storing programming, such as processor executable code or instructions (e.g., software, firmware), electronic data, databases, or other digital information. The storage medium 804 may also be used for storing data that is manipulated by the processing circuit 810 when executing programming. The storage medium 804 may be any available media that can be accessed by a general purpose or special purpose processor, including portable or fixed storage devices, optical storage devices, and various other mediums capable of storing, containing or carrying programming.

By way of example and not limitation, the storage medium 804 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The storage medium 804 may be embodied in an article of manufacture (e.g., a computer program product). By way of example, a computer program product may include a computer-readable storage medium in packaging materials. In view of the above, in some implementations, the storage medium 804 may be a non-transitory (e.g., tangible) storage medium.

Alternatively, in some implementations, a computer-readable storage medium may include, by way of example, a carrier wave, a transmission line, and any other suitable medium for transmitting software and/or instructions that may be accessed and read by a computer.

The storage medium 804 may be coupled to the receiver 816 such that the receiver 816 may read information from, and write information to, the storage medium 804. That is, the storage medium 804 may be coupled to the receiver 816 so that the storage medium 804 is at least accessible by the receiver 816, including examples where at least one storage medium is integral to the receiver 816 and/or examples where at least one storage medium is separate from the receiver 816 (e.g., resident in the apparatus 800, external to the apparatus 800, distributed across multiple entities, etc.).

According to at least one example of the apparatus 800, the receiver 816 may include one or more of a module for receiving a multiplexed signal, a module for performing channel estimation by using a first training sequence code (TSC₁ₛₜ) for the first user signal and a second training sequence code (TSC_{2nd}) for the second user signal, a module for performing channel estimation by using the second training sequence code (TSC_{2nd}) for the first user signal and the second user signal, a module for obtaining at least one channel parameter from the channel estimation, or a module for performing user signal demodulation for the first user signal and/or the second user signal using the at least one channel parameter.

The module 820 for receiving a multiplexed signal (e.g., a module 830 for receiving a multiplexed signal stored on the storage medium 804) may be adapted to receive the multiplexed signal which may include a first user signal having a first amplitude and a second user signal having a second amplitude.

The module 822 for performing channel estimation by using a first training sequence code (TSC₁ₛₜ) for the first user signal and a second training sequence code (TSC_{2nd}) for the second user signal (e.g., a module 832 for performing channel estimation by using a first training sequence code (TSC₁ₛₜ) for the first user signal and a second training sequence code (TSC_{2nd}) for the second user signal stored on the storage medium 804) may be adapted to perform the channel estimation for each user signal separately prior to user signal demodulation of the first user signal and/or the second user signal.

The module 824 for performing channel estimation by using the second training sequence code (TSC_{2nd}) for the first user signal and the second user signal (e.g., a module 834 for performing channel estimation by using the second training sequence code (TSC_{2nd}) for the first user signal and the second user signal stored on the storage medium 804) may be adapted to perform the channel estimation (prior to user signal demodulation) for each of the first and second user signals as a single channel estimation by using the second training sequence code (TSC_{2nd}) since the second amplitude of the second user signal is higher than the first amplitude of the first user signal.

The module 826 for obtaining at least one channel parameter from the channel estimation (e.g., a module 836 for obtaining at least one channel parameter from the channel estimation stored on the storage medium 804) may be adapted to obtain the at least one channel parameter which may include a timing reference and/or a frequency estimate.

The module 828 for performing user signal demodulation (e.g., a module 838 for performing user signal demodulation stored on the storage medium 804) may be adapted to perform user signal demodulation for the first user signal, subsequent to the channel estimation, using the at least one channel parameter which may include a timing reference and/or a frequency estimate.

As mentioned above, programming stored by the storage medium 804, when executed by the receiver 816, causes the receiver 816 to perform one or more of the various functions and/or process operations described herein. For example, the storage medium 804 may include one or more of the modules (e.g., operations) for receiving a multiplexed sign (e.g., module 830), for performing channel estimation by using a first training sequence code (TSC₁ₛₜ) for the first user signal and a second training sequence code (TSC_{2nd}) for the second user signal (e.g., module 832), for performing channel estimation by using the second training sequence code (TSC_{2nd}) for the first user signal and the second user signal (e.g., module 834), for obtaining at least one channel parameter from the channel estimation (e.g., module 836), or performing user signal demodulation (e.g., module 838).

The storage medium 804 may also be coupled to the processing circuit 810 such that the processing circuit 810 may read information from, and write information to, the storage medium 804. That is, the storage medium 804 may be coupled to the processing circuit 810 so that the storage medium 804 is at least accessible by the processing circuit 810, including examples where at least one storage medium is integral to the processing circuit 810 and/or examples where at least one storage medium is separate from the processing circuit 810 (e.g., resident in the apparatus 800, external to the apparatus 800, distributed across multiple entities, etc.).

Programming stored by the storage medium 804, when executed by the processing circuit 810, causes the processing circuit 810 to perform one or more of the various functions and/or process operations described herein. For example, the storage medium 804 may include operations configured for regulating operations at one or more hardware blocks of the processing circuit 810, as well as to utilize the communication interface 802 for wireless communication utilizing their respective communication protocols.

The processing circuit 810 is generally adapted for processing, including the execution of such programming stored on the storage medium 804. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 810 is arranged to obtain, process and/or send data, control data access and storage, issue commands, and control other desired operations. The processing circuit 810 may include circuitry configured to implement desired programming provided by appropriate media in at least one example. For example, the processing circuit 810 may be implemented as one or more processors, one or more controllers, and/or other structure configured to execute executable programming. Examples of the processing circuit 810 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 810 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 810 are for illustration and other suitable configurations within the scope of the disclosure are also contemplated.

According to one or more aspects of the disclosure, the processing circuit 810 may be adapted to perform any or all of the features, processes, functions, operations and/or routines for any or all of the apparatuses described herein. As used herein, the term “adapted” in relation to the processing circuit 810 may refer to the processing circuit 810 being one or more of configured, employed, implemented, and/or programmed to perform a particular process, function, operation and/or routine according to various features described herein.

According to at least one example of the apparatus 800, the processing circuit 810 may include one or more of a module for computing a subchannel power imbalance ratio (SCPIR), or a module for comparing the SCPIR to a predetermined SCPIR threshold.

The module 840 for computing a subchannel power imbalance ratio (SCPIR) (e.g., a module 850 for computing a subchannel power imbalance ratio (SCPIR) stored on the storage medium 804) may be adapted to compute the subchannel power imbalance ratio (SCPIR) based on a first amplitude of the first user signal and a second amplitude of the second user signal, for example, by using a function (F) defined as 20 times the logarithm of the ratio of the first amplitude over the second amplitude.

The module 842 for comparing the SCPIR to a predetermined SCPIR threshold (e.g., a module 852 for comparing the SCPIR to a predetermined SCPIR threshold stored on the storage medium 804) adapted to determine if the interference from the second user signal to the first user signal is either negligible or moderate (i.e., a benign interference scenario when the SCPIR being greater than the SCPIR threshold), or if the interference from the second user signal to the first user signal is high (i.e., a harsh interference scenario (a.k.a., a harsh SCPIR scenario) with the SCPIR being less than or equal to the SCPIR threshold).

As mentioned above, programming stored by the storage medium 804, when executed by the processing circuit 810, causes the processing circuit 810 to perform one or more of the various functions and/or process operations described herein. For example, the storage medium 804 may include one or more of the modules (e.g., operations) for computing a subchannel power imbalance ratio (SCPIR) (e.g., module 850), or for comparing the SCPIR to a predetermined SCPIR threshold (e.g., module 852).

The modules of FIG. 8 described herein may conduct one or more of the operations described herein at FIG. 7.

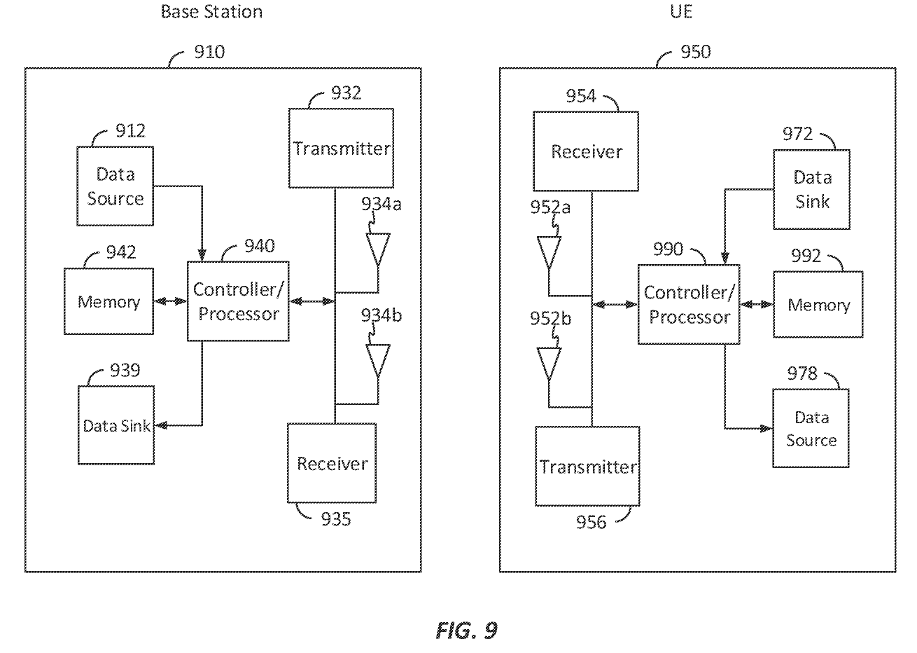

FIG. 9 is a block diagram of a base station 910 in communication with a UE 950, where the base station 910 may be the BTS 208 in FIG. 2, and the UE 950 may be the UE 210 in FIG. 2. In the downlink communication, a controller or processor 940 may receive data from a data source 912. Channel estimates may be used by a controller/processor 940 to determine the coding, modulation, spreading, and/or scrambling schemes for the transmit processor 920. These channel estimates may be derived from a reference signal transmitted by the UE 950 or from feedback from the UE 950. A transmitter 932 may provide various signal conditioning functions including amplifying, filtering, and modulating frames onto a carrier for downlink transmission over a wireless medium through one or more antennas 934. The antennas 934 may include one or more antennas, for example, including beam steering bidirectional adaptive antenna arrays, MIMO arrays, or any other suitable transmission/reception technologies.

At the UE 950, a receiver 954 receives the downlink transmission through one or more antennas 952 and processes the transmission to recover the information modulated onto the carrier. The information recovered by the receiver 954 is provided to a controller/processor 990. The processor 990 descrambles and despreads the symbols, and determines the most likely signal constellation points transmitted by the base station 910 based on the modulation scheme. These soft decisions may be based on channel estimates computed by the processor 990. The soft decisions are then decoded and deinterleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded, the controller/processor 990 may also use an acknowledgement (ACK) and/or negative acknowledgement (NACK) protocol to support retransmission requests for those frames.

In the uplink, data from a data source 978 and control signals from the controller/processor 990 are provided. The data source 978 may represent applications running in the UE 950 and various user interfaces (e.g., keyboard). Similar to the functionality described in connection with the downlink transmission by the base station 910, the processor 990 provides various signal processing functions including CRC codes, coding and interleaving to facilitate FEC, mapping to signal constellations, spreading with OVSFs, and scrambling to produce a series of symbols. Channel estimates, derived by the processor 990 from a reference signal transmitted by the base station 910 or from feedback contained in a midamble transmitted by the base station 910, may be used to select the appropriate coding, modulation, spreading, and/or scrambling schemes. The symbols produced by the processor 990 will be utilized to create a frame structure. The processor 990 creates this frame structure by multiplexing the symbols with additional information, resulting in a series of frames. The frames are then provided to a transmitter 956, which provides various signal conditioning functions including amplification, filtering, and modulating the frames onto a carrier for uplink transmission over the wireless medium through the one or more antennas 952.

The uplink transmission is processed at the base station 910 in a manner similar to that described in connection with the receiver function at the UE 950. A receiver 935 receives the uplink transmission through the one or more antennas 934 and processes the transmission to recover the information modulated onto the carrier. The information recovered by the receiver 935 is provided to the processor 940, which parses each frame. The processor 940 performs the inverse of the processing performed by the processor 990 in the UE 950. The data and control signals carried by the successfully decoded frames may then be provided to a data sink 939. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the base station 910 and the UE 950, respectively. For example, the controller/processors 940 and 990 may provide various functions including timing, peripheral interfaces, voltage regulation, power management, and other control functions. The computer-readable storage media of memories 942 and 992 may store data and software for the base station 910 and the UE 950, respectively.

Several aspects of a telecommunications system have been presented with reference to a GSM/EDGE Radio Access Network (GERAN) system. As those skilled in the art will readily appreciate, various aspects described throughout this disclosure may be extended to other telecommunication systems, network architectures and communication standards. For example, the concepts disclosed can be applied to any time-division-based system, such as but not limited to a UMTS system using a TDD air interface, or an e-UTRA system using a TD-LTE air interface. Especially in the multi-SIM (e.g., dual-SIM) examples, the subscriptions might be on any of these types of systems.

By way of further example, various aspects may be extended to other systems such as TD-SCDMA, TD-CDMA, and W-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

While the above discussed aspects, arrangements, and embodiments are discussed with specific details and particularity, one or more of the components, operations, features and/or functions illustrated in FIG. 7 may be rearranged and/or combined into a single component, operation, feature or function or embodied in several components, operations, or functions. Additional elements, components, operations, and/or functions may also be added or not utilized without departing from the teachings herein. The apparatus, devices and/or components illustrated in one or more of FIG. 1, 2, 4, 8 or 9 may be configured to perform or employ one or more of the methods, features, parameters, or operations described in FIG. 7. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm operations described in connection with the embodiments disclosed herein may be implemented as hardware, software, firmware, middleware, microcode, or any combination thereof. To clearly illustrate this interchangeability, various illustrative components, blocks, modules, circuits, and operations have been described above generally in terms of their functionality. Whether such functionality is implemented as hardware or software depends upon the particular application and design constraints imposed on the overall system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A method of wireless communication, comprising:
receiving a multiplexed signal, wherein the multiplexed signal includes a first user signal having a first amplitude and a second user signal having a second amplitude;
computing a subchannel power imbalance ratio (SCPIR) based on the first amplitude of the first user signal and the second amplitude of the second user signal;
performing a channel estimation for the first user signal and the second user signal;
obtaining at least one channel parameter from the channel estimation; and
performing a user signal demodulation for the first user signal or the second user signal using the at least one channel parameter.

2. The method of claim 1, further comprising comparing the SCPIR to a SCPIR threshold.

3. The method of claim 2, wherein the SCPIR is greater than the SCPIR threshold.

4. The method of claim 3, further comprising determining that interference from the second user signal to the first user signal is a benign interference scenario when the interference is less than a predefined performance level.

5. The method of claim 4, further comprising performing the channel estimation by using a first training sequence code (TSC₁ₛₜ) for the first user signal and a second training sequence code (TSC_{2nd}) for the second user signal.

6. The method of claim 5, wherein the first training sequence code (TSC₁ₛₜ) and the second training sequence code (TSC_{2nd}) are distinct digital training sequence codes.

7. The method of claim 6, wherein the first training sequence code (TSC₁ₛₜ) and the second training sequence code (TSC_{2nd}) include a low cross-correlation characteristic.

8. The method of claim 2, wherein the SCPIR is less than or equal to the SCPIR threshold.

9. The method of claim 8, further comprising determining that interference from the second user signal to the first user signal is a harsh SCPIR scenario when the interference is greater than or equal to a predefined performance level.

10. The method of claim 9, further comprising performing the channel estimation by using a second training sequence code (TSC_{2nd}) for the first user signal and the second user signal, wherein the second training sequence code (TSC_{2nd}) is associated with the second user signal.

11. The method of claim 10, wherein the second training sequence code (TSC_{2nd}) is a deterministic digital sequence including a series of binary values.

12. The method of claim 1, wherein the multiplexed signal includes at least two orthogonal signal components.

13. The method of claim 1, wherein the at least two orthogonal signal components include an in-phase component and a quadrature component.

14. The method of claim 1, wherein the SCPIR is computed as twenty (20) times a logarithm of a ratio of the first amplitude over the second amplitude.

15. The method of claim 1, wherein the at least one channel parameter is one of a timing estimate or a frequency estimate.

16. The method of claim 1, further comprising subtracting the second user signal from the multiplexed signal to obtain a suppressed multiplexed signal.

17. The method of claim 16, further comprising performing the user signal demodulation for the first user signal or the second user signal based on the suppressed multiplexed signal.

18. An apparatus for wireless communication, comprising:
a memory;
an antenna for receiving a multiplexed signal, wherein the multiplexed signal includes a first user signal having a first amplitude and a second user signal having a second amplitude;
a controller coupled to the memory for computing a subchannel power imbalance ratio (SCPIR) based on the first amplitude of the first user signal and the second amplitude of the second user signal; and
a receiver coupled to the controller and the antenna for the following:
performing a channel estimation for the first user signal and the second user signal;
obtaining at least one channel parameter from the channel estimation; and
performing a user signal demodulation for the first user signal or the second user signal using the at least one channel parameter.

19. The apparatus of claim 18, wherein the controller is configured for comparing the SCPIR to a SCPIR threshold.

20. The apparatus of claim 19, wherein the SCPIR is greater than the SCPIR threshold; and
wherein the controller is configured for determining that interference from the second user signal to the first user signal is a benign interference scenario when the interference is less than a predefined performance level.

21. The apparatus of claim 20, wherein the receiver is configured for performing the channel estimation by using a first training sequence code (TSC₁ₛₜ) for the first user signal and a second training sequence code (TSC_{2nd}) for the second user signal, and the first training sequence code (TSC₁ₛₜ) and the second training sequence code (TSC_{2nd}) are distinct digital training sequence codes.

22. The apparatus of claim 19, wherein the SCPIR is less than or equal to the SCPIR threshold;
wherein the controller is configured for determining that interference from the second user signal to the first user signal is a harsh SCPIR scenario when the interference is greater than or equal to a predefined performance level; and
wherein the receiver is configured for performing the channel estimation by using a second training sequence code (TSC_{2nd}) for the first user signal and the second user signal, and the second training sequence code (TSC_{2nd}) is associated with the second user signal.

23. The apparatus of claim 18, wherein the receiver is configured for subtracting the second user signal from the multiplexed signal to obtain a suppressed multiplexed signal and configured for performing the user signal demodulation for the first user signal or the second user signal based on the suppressed multiplexed signal.

24. An apparatus for wireless communication, comprising:
a memory;
means for receiving a multiplexed signal, wherein the multiplexed signal includes a first user signal having a first amplitude and a second user signal having a second amplitude;
means for computing a subchannel power imbalance ratio (SCPIR) based on the first amplitude of the first user signal and the second amplitude of the second user signal;
means for performing a channel estimation for the first user signal and the second user signal;
means for obtaining at least one channel parameter from the channel estimation; and
means for performing a user signal demodulation for the first user signal or the second user signal using the at least one channel parameter.

25. The apparatus of claim 24, further comprising means for comparing the SCPIR to a SCPIR threshold.

26. The apparatus of claim 25, wherein the SCPIR is greater than the SCPIR threshold; and
further comprising means for determining that interference from the second user signal to the first user signal is a benign interference scenario when the interference is less than a predefined performance level.

27. The apparatus of claim 26, further comprising means for performing the channel estimation by using a first training sequence code (TSC₁ₛₜ) for the first user signal and a second training sequence code (TSC_{2nd}) for the second user signal; wherein the first training sequence code (TSC₁ₛₜ) and the second training sequence code (TSC_{2nd}) are distinct digital training sequence codes.

28. The apparatus of claim 25, wherein the SCPIR is less than or equal to the SCPIR threshold; and
further comprising:
means for determining that interference from the second user signal to the first user signal is a harsh SCPIR scenario when the interference is greater than or equal to a predefined performance level; and
means for performing the channel estimation by using a second training sequence code (TSC_{2nd}) for the first user signal and the second user signal, wherein the second training sequence code (TSC_{2nd}) is associated with the second user signal.

29. The apparatus of claim 24, further comprising:
means for subtracting the second user signal from the multiplexed signal to obtain a suppressed multiplexed signal; and
means for performing the user signal demodulation for the first user signal or the second user signal based on the suppressed multiplexed signal.

30. A computer-readable storage medium storing computer executable code, operable on a device comprising at least one processor; a memory for storing a subchannel power imbalance ratio (SCPIR) threshold, the memory coupled to the at least one processor; and
the computer executable code comprising:
instructions for causing the at least one processor to receive a multiplexed signal, wherein the multiplexed signal includes a first user signal having a first amplitude and a second user signal having a second amplitude;
instructions for causing the at least one processor to compute a subchannel power imbalance ratio (SCPIR) based on the first amplitude of the first user signal and the second amplitude of the second user signal;
instructions for causing the at least one processor to compare the SCPIR to the SCPIR threshold to generate a comparison;
instructions for causing the at least one processor to perform a channel estimation for the first user signal and the second user signal based on the comparison;
instructions for causing the at least one processor to obtain at least one channel parameter from the channel estimation; and
instructions for causing the at least one processor to perform a user signal demodulation for the first user signal or the second user signal using the at least one channel parameter.
